(19) United States
(12) Patent Application Publication
(10) Pub. No.: US 2013/0120542 A1
(43) Pub. Date: May 16, 2013

(54) 3D MEDIA PLAYING DEVICE

(71) Applicant: Cheng Shang, Shenzhen (CN)

(72) Inventor: Cheng Shang, Shenzhen (CN)

(73) Assignee: NVIDIA CORPORATION, Santa Clara, CA (US)

(21) Appl. No.: 13/421,510

(22) Filed: Mar. 15, 2012

(30) Foreign Application Priority Data
Nov. 11, 2011 (CN) 201110356040.6

(51) Int. Cl. H04N 13/04

(52) U.S. Cl. 348/51; 348/E13.075

(57) ABSTRACT

In one embodiment, a portable 3D media playing device comprises: a telescope-shaped housing; at least one display for displaying video data; and a circuit board coupled to the display for processing video data and transmitting the video data to the display.

### CROSS-REFERENCE TO RELATED APPLICATION

This patent application claims the benefit and priority of the co-pending Chinese Patent Application No. 201110356040.6, by Cheng SHANG, filed on Nov. 11, 2011, Attorney Docket Number P2011165, which is hereby incorporated by reference.

### BACKGROUND

As we all know, a principle of a three-dimensional (3D) experience is that a 3D film displays both a left-eye image and a corresponding right-eye image. In the conventional art, a 3D imaging system includes 3D glasses and 3D projectors and so on. During use the 3D glasses need to function together with the 3D projectors. Moreover, 3D projectors are usually too large to carry and cost too much. Ordinary consumers can enjoy the 3D experience only in the cinema.

### SUMMARY

Accordingly, there is a need in the art for a portable 3D media playing device, which is portable and convenient for a user to enjoy the 3D experience everywhere while the cost is low enough for ordinary consumers to purchase and use it.

In order to solve the problem mentioned above, an embodiment in accordance with the present invention includes a portable 3D media playing device. In one embodiment, the portable 3D media playing device comprises: a telescope-shaped housing; at least one display for displaying video data; and a circuit board coupled to the display for processing video data and transmitting the video data to the display.

In an embodiment, the display is set in the objective position of a telescope-shaped housing.

In an embodiment, the display is a liquid crystal display.

In an embodiment, the display comprises a left eye display and a right eye display, which are put in the left objective position and in the right objective position, respectively.

In an embodiment, the horizontal widths of the left eye display and the right eye display are both 4-20 centimeters (cm).

In an embodiment, the left eye display and the right eye display are both 3.0 inch liquid crystal displays.

In an embodiment, an eyepiece position of the telescope-shaped housing is for the user to watch the display through.

In an embodiment, the horizontal distance between the eyepiece position and the liquid crystal display is 3-35 cm.

In an embodiment, the horizontal distance between the eyepiece position and the liquid crystal display is 22-28 cm.

In an embodiment, the horizontal distance between the eyepiece position and the liquid crystal display is 25 cm.

In an embodiment, the eyepiece position of the telescope-shaped housing further comprises a left eye position and a right eye position for a left eye and right eye to look through respectively.

In an embodiment, the distance between the centers of the left eye position and the right eye position is 4-15 cm.

In an embodiment, the distance between the centers of the left eye position and the right eye position is 6-7 cm.

In an embodiment, the portable 3D media playing device further comprises an opaque board for isolating the left vision from the right vision.

In an embodiment, the thickness of the opaque board is less than 0.5 cm.

In an embodiment, the thickness of the opaque board is less than 0.25-0.35 cm.

In an embodiment, the thickness of the opaque board is less than 0.3 cm.

In an embodiment, a metal box is put inside the device and the circuit board is put in the metal box.

In an embodiment, the circuit board further comprises a microprocessor, memory and an eMMC (embedded multimedia card).

In an embodiment, the circuit board further comprises a microprocessor, wherein the microprocessor is an NVIDIA® Tegra® 2.0 or NVIDIA® Tegra® 3.0.

In an embodiment, a device comprises a first display, a second display, and a processor. The processor is coupled to the first and second displays. The processor is for transmitting a first video to the first display and a second video to the second display. The first video is for viewing by a first eye of a user and the second video is for viewing by a second eye of the user. The device is a 3D media playing device.

In an embodiment, a device comprises a memory, a first display, a second display, and a microprocessor. The microprocessor is coupled to the first and second displays and the memory. The microprocessor is for transmitting a first video to the first display and a second video to the second display. The first video is for viewing by a first eye of a user and the second video is for viewing by a second eye of the user. The device also comprises an opaque board located between the first display and the second display. The device is a 3D media playing device.

In an embodiment, a device comprises a first liquid crystal display, a second liquid crystal display, and a circuit board. The circuit board is coupled to the first and second liquid crystal displays and the memory. The circuit board is for transmitting a first video to the first liquid crystal display and a second video to the second liquid crystal display. The first video is for viewing by a first eye of a user and the second video is for viewing by a second eye of the user. The device is a 3D media playing device.

The portable 3D media playing device of an embodiment in accordance with the present invention is as small as an ordinary telescope and can be put in a bag casually to carry and the cost is low. Compared with the 3D glasses and 3D displays in the market currently, the portable 3D media playing device of an embodiment in accordance with the present invention costs less and is suitable for ordinary consumers to purchase and use it.

Additional features and advantages of various embodiments in accordance with the invention will be set forth in the description that follows, and in part will be apparent from the description, or may be learned by practice of various embodiments in accordance with the invention. The advantages of the various embodiments in accordance with the invention will be realized and attained by the structures particularly pointed out in the written description and claims hereof as well as the appended drawings.

It is to be understood that both the foregoing general description and the following detailed description are exemplary and explanatory and are intended to provide further explanation of the invention as claimed.

While particular embodiments in accordance with the invention have been specifically described within this Summary, it is noted that the invention and the claimed subject matter are not limited in any way by these embodiments.

### BRIEF DESCRIPTION OF THE DRAWINGS

The accompanying drawings are included to provide a further understanding of various embodiments in accordance with the invention, and are incorporated in and constitute a part of this specification. The drawings illustrate various embodiments of the invention and, together with the description, serve to explain principles of various embodiments in accordance with the invention.

FIG. 1 is a top view of a portable 3D media playing device in accordance with one embodiment of the present invention.

FIG. 2 is a side view of a portable 3D media playing device in accordance with one embodiment of the present invention.

FIG. 3 illustrates a structure diagram of a system in accordance with an embodiment of the present invention, wherein a circuit board couples to a display in a 3D media playing device.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details or with equivalents thereof. In other instances, well known methods, procedures, components, and circuits have not been described in detail as not to unnecessarily obscure aspects of the invention.

Various example embodiments are described herein in the context of a portable 3D media playing device. Those of ordinary skill in the art will realize that the following description is illustrative only and is not intended to be in any way limiting. Other embodiments will readily suggest themselves to those skilled in the art having the benefit of this disclosure. Reference will now be made in detail to implementations of the example embodiments as illustrated in the accompanying drawings. The same reference indicators will be used to the extent possible throughout the drawings and the following description to refer to the same or like items.

Various embodiments in accordance with the present invention relate generally to circuit technology and, in particular, to a 3D media playing device and, in particular, to a portable 3D media playing device.

Reference will now be made in detail to various embodiments in accordance with the present invention, examples of which are illustrated in the accompanying drawings.

A portable 3D media playing device in accordance with an embodiment of the present invention is based on the principle of a 3D experience. In an embodiment, a left eye video is displayed on a liquid crystal display (LCD) that can be just viewed by a user's left eye and a right eye video is displayed on a LCD that can be just viewed by the user's right eye. In one embodiment, an opaque board is placed in the middle of the two LCDs so that the right eye cannot see the video for the left eye and the left eye cannot see the video for the right eye. The left eye video and right eye video could be offered by a 3D film provider, such as a film production company.

A portable 3D media playing device in accordance with an embodiment of the present invention is shaped like a telescope. In an embodiment, two plain lenses can be located in the two eyepiece positions, but it is appropriate if no lens is mounted. In an embodiment, a LCD displaying videos for the left eye and a LCD displaying videos for the right eye are put in the left objective position and in the right objective position, respectively. In one embodiment, a circuit board is put on an upper surface of the bottom of the telescope-shaped housing below the LCDs and it is used for controlling video data processing and transmitting the video data to the LCDs.

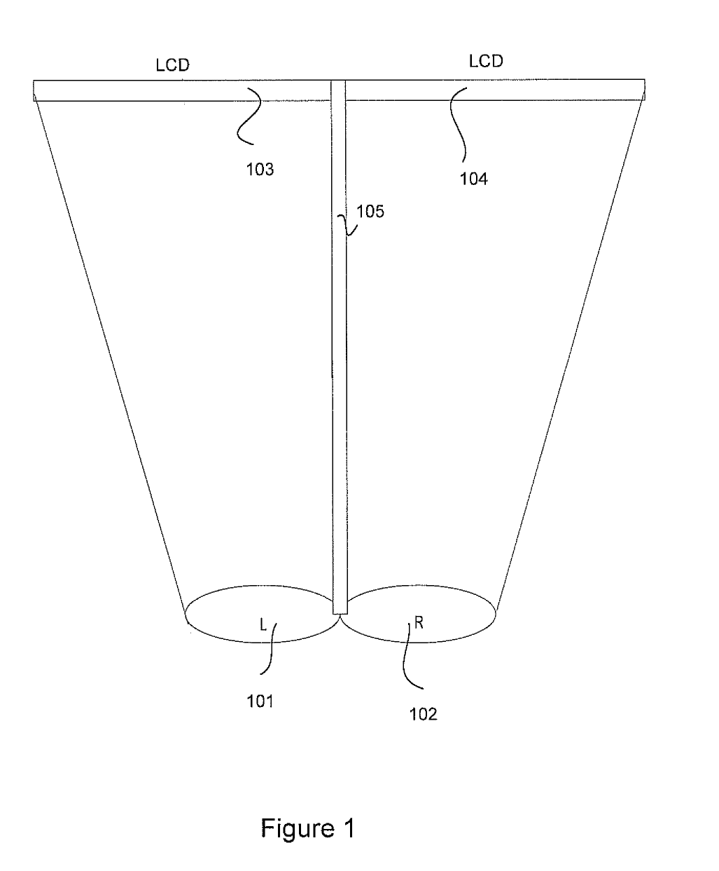

FIG. 1 is a top view of a portable 3D media playing device in accordance with one embodiment of the present invention. In an embodiment, the portable 3D media playing device is shaped like a telescope. The left eye and the right eye of a user look into the device through the left eyepiece 101 and the right eyepiece 102. In an embodiment, the left eyepiece 101 and the right eyepiece 102 are round and the distance between their centers is 4-15 cm. In one embodiment, the distance between their centers can be 6-7 cm, which is the papillary distance of a human being.

In an embodiment, a left eye LCD 103 and a right eye LCD 104 are put in the left objective position and in the right objective position, respectively. The left eye LCD 103 displays videos for a user's left eye and the right eye LCD 104 displays videos for the user's right eye. In an embodiment, the horizontal width of each LCD is 4-20 cm. In one embodiment, the horizontal width of each LCD can be 9-10 cm. In an embodiment, the distance between the left eyepiece 101 and the left eye LCD 103, e.g., the horizontal length of the telescope shaped housing is 3-35 cm. In one embodiment, the horizontal length of the telescope shaped housing can be 22-28 cm. In an embodiment, the horizontal length of the telescope shaped housing can be 25 cm.

As shown in FIG. 1, in an embodiment, there is an opaque board 105 located in the middle of the left eye LCD 103 and the right eye LCD 104 for isolating the left vision from the right vision. In an embodiment, the thickness of the opaque board 105 is less than 0.5 cm. In one embodiment, the thickness of the opaque board 105 can be 0.25-0.35 cm.

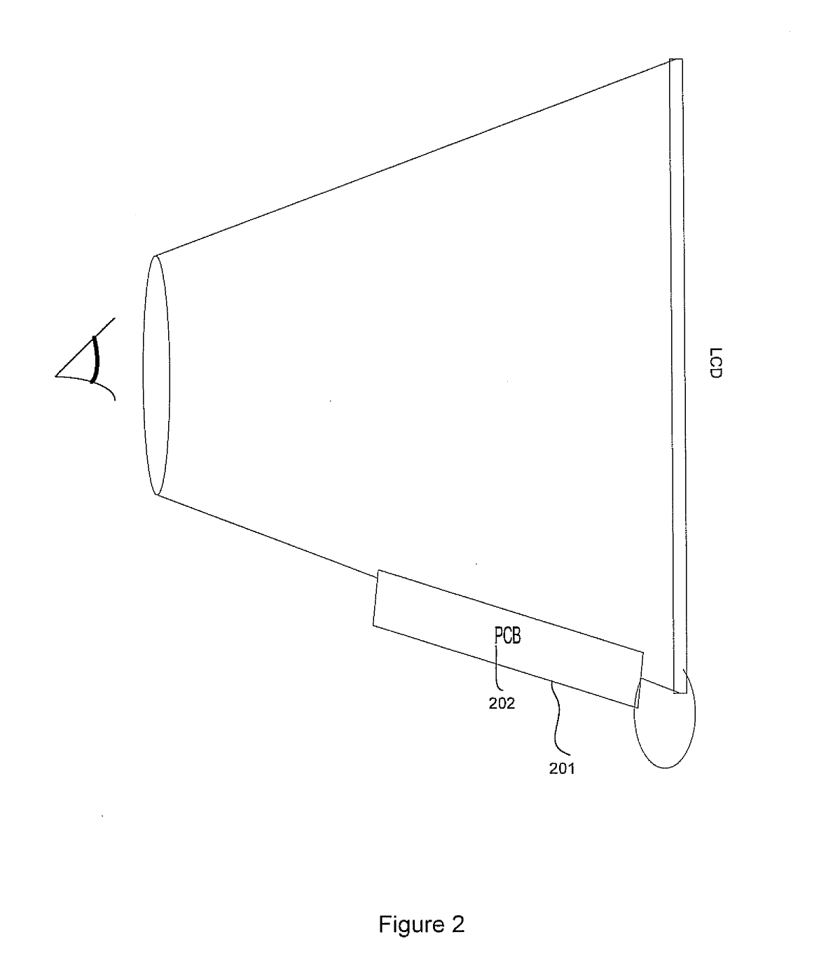

FIG. 2 is a side view of a portable 3D media playing device in accordance with one embodiment of the present invention. As shown in FIG. 2, in an embodiment, a metal box 201 is on an upper surface of the bottom of the telescope-shaped housing below the LCDs. In an embodiment, a circuit board 202 is fixed in the metal box 201 and a chip is on the circuit board 202 for processing and transmitting video data. In one embodiment, the metal box 201 is in the portable 3D media playing device and the circuit board 202 is put in the metal box 201. As shown in FIG. 2, in an embodiment, the vertical height of each LCD is 3-20 cm. In one embodiment, the vertical height of each LCD can be 5-6 cm.

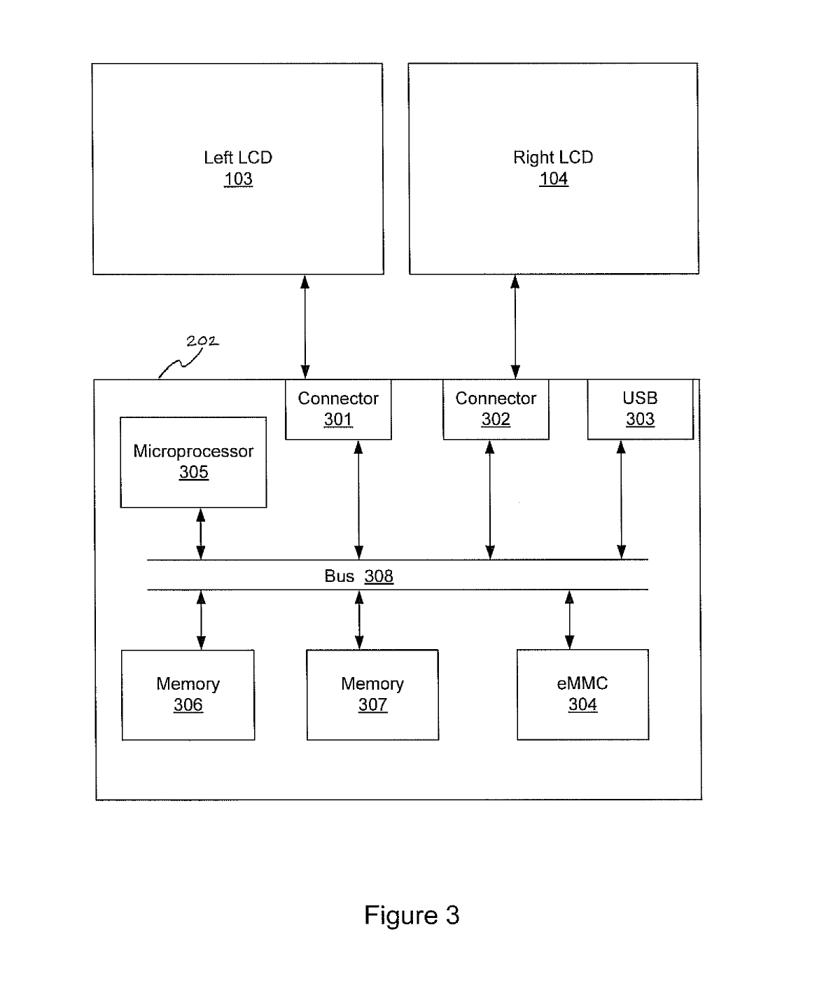

FIG. 3 illustrates a structure diagram of a system in accordance with an embodiment of the present invention, wherein a circuit board couples to a display in a 3D media playing device. As shown in FIG. 3, a circuit board 202 couples to the left eye LCD 103 and the right eye LCD 104 by a first connector 301 and a second connector 302, respectively, so as to transmit video data from a microprocessor 305. In an embodiment, the circuit board 202 comprises the microprocessor 305, a first memory 306, a second memory 307, an eMMC (embedded multimedia card) 304, a USB connector 303, the first connector 301, the second connector 302 and a bus 308. In an embodiment, the processor 305, the first memory 306, the second memory 307, the eMMC (embedded multimedia card) 304, the first connector 301 and the second connector 302 are coupled and communicate through the bus 308 so that during the display of the video, the microprocessor 305 reads video data from the eMMC 304 and processes the video data using the first memory 306 and the second memory 307. The processed video data are transmitted to the left eye LCD 103 and the right eye LCD 104 by the first connector 301 and the second connector 302, respectively.

In an embodiment, the microprocessor 305 can be an NVIDIA® Tegra® 2.0 or an NVIDIA® Tegra® 3.0. In an embodiment, the eMMC 304 can be the Hynix or SanDisk® brand, such as the Hynix eMMC, whose part number is H26M52002CKR and whose package size is 14×18×1.2 millimeters (mm). In an embodiment, for the first memory 306 and the second memory 307, we could use the brand of Samsung or Hynix, for example, Samsung memory whose part number is K4P1G164EE. In an embodiment, the first connector 301, the second connector 302 and the USB connector 303 can use parts widely known in the field. In an embodiment, each LCD could be a 3.0 inch TFT (Thin Film Transistor) LCD display with resolution 400×240, which is 5.4 cm long and 9.52 cm wide.

In accordance with one embodiment, the rule for data transmission is: when the microprocessor 305 starts to transmit the head of the nth left-eye frame to the left LCD 103, it starts to transmit the nth right-eye frame to the right LCD 104. When both the nth left-eye frame and right-eye frame are transmitted, the microprocessor 305 starts to transmit the nth+1 left-eye frame. Thus, synchronization is ensured of the left-eye frame and right-eye frame.

Therefore, a portable 3D media playing device in accordance with an embodiment of the present invention is as small as an ordinary telescope and can be put in a bag casually to carry while its cost is low. Compared with the 3D glasses and 3D displays in the market currently, a portable 3D media playing device in accordance with an embodiment of the present invention cost less and is suitable for ordinary consumers to purchase and use it.

It should be appreciated that various modifications, adaptations and alternative embodiments thereof may be made within the scope and spirit of the present invention. The invention is further defined by the following claims.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the Claims and their equivalents.

What is claimed is:

1. A device comprising:
a first display;
a second display; and
a processor coupled to the first and second displays, the processor for transmitting a first video to the first display and a second video to the second display, the first video is for viewing by a first eye of a user and the second video is for viewing by a second eye of the user,
the device is a three-dimensional (3D) media playing device.

2. The device of claim 1, further comprising:
a housing for the first display, the second display, and the processor.

3. The device of claim 2, wherein the housing comprises a first eyepiece and a second eyepiece.

4. The device of claim 3, further comprising:
an opaque board located between the first display and the second display, the opaque board extends from the first and second displays to the first and second eyepieces.

5. The device of claim 1, further comprising:
an opaque board located between the first display and the second display.

6. The device of claim 5, wherein the first display comprises a liquid crystal display and the second display comprises a liquid crystal display.

7. The device of claim 1, wherein the first display comprises a liquid crystal display and the second display comprises a liquid crystal display.

8. The device of claim 1, further comprising:
memory coupled to the processor.

9. A device comprising:
a memory;
a first display;
a second display;
a microprocessor coupled to the first and second displays and the memory, the microprocessor for transmitting a first video to the first display and a second video to the second display, the first video is for viewing by a first eye of a user and the second video is for viewing by a second eye of the user; and
an opaque board located between the first display and the second display,
the device is a three-dimensional (3D) media playing device.

10. The device of claim 9, further comprising:
a housing for the first display, the second display, the opaque board, the processor, and the memory.

11. The device of claim 10, wherein the housing comprises a first eyepiece and a second eyepiece.

12. The device of claim 11, wherein the opaque board extends from the first and second displays to the first and second eyepieces.

13. The device of claim 9, wherein the first display comprises a liquid crystal display and the second display comprises a liquid crystal display.

14. The device of claim 9, further comprising:
a multimedia card coupled to the processor.

15. The device of claim 14, further comprising:
a circuit board comprising the microprocessor, the memory, and the multimedia card.

16. A device comprising:
a first liquid crystal display;
a second liquid crystal display; and
a circuit board coupled to the first and second liquid crystal displays, the circuit board for transmitting a first video to the first liquid crystal display and a second video to the second liquid crystal display, the first video is for viewing by a first eye of a user and the second video is for viewing by a second eye of the user,
the device is a three-dimensional (3D) media playing device.

17. The device of claim 16, further comprising:
a housing for the first liquid crystal display, the second liquid crystal display, and the circuit board.

18. The device of claim 17, wherein the housing comprises a first eyepiece and a second eyepiece.

19. The device of claim 18, further comprising:
an opaque board located between the first display and the second display, the opaque board extends from the first and second liquid crystal displays to the first and second eyepieces.

20. The device of claim 16, further comprising:
an opaque board located between the first display and the second display.
